(19) United States
(12) Patent Application Publication
(10) Pub. No.: US 2007/0265429 A1
(43) Pub. Date: Nov. 15, 2007

(54) Use of a vibratory spiral elevator for crystallizing and/or drying of plastic pellets

(76) Inventor: Andrew Steven Hudson, White Oak, TX (US)

Correspondence Address: Dennis V. Carmen;Eastman Chemical Company, P.O. Box 511, Kingsport, TN, 37662-5075, US

(21) Appl. No.: 11/431,770

(22) Filed: May 10, 2006

(51) Int. Cl. B29C 47/88

(52) U.S. Cl. 528/503; 264/211.13

(57) ABSTRACT

A method and system for processing a polymer includes providing a molten polymer and processing the polymer into malleable components for delivery to a spirally wound conveying surface. Vibratory forces may be utilized to urge the components along the length of the conveying surface as they undergo crystallizing or drying or crystallizing and drying. Additional supplemental temperature control may be employed to affect crystallization and/or drying of the components along the conveying surface.

### FIELD OF THE INVENTION

The present invention relates generally to processing of polymer products. More particularly, the present invention relates to utilizing a vibratory spiral elevator for crystallizing and/or drying of plastic pellets.

### BACKGROUND OF THE INVENTION

Treatment processes and associated equipment can play important roles in a vast amount of polymer processing industries. In some instances, such treatment processes and equipment may include those conducive to crystallizing or drying or crystallizing and drying of plastic products (e.g., poly(ethylene terephthalate) (PET), Polyethylene (PE), and Polypropylene (PP)). It should be appreciated that crystallization of a plastic product generally requires obtaining a prescribed temperature of that product. However, obtaining and/or maintaining a sufficient temperature for crystallization of the plastic product after it is produced can prove challenging.

In some instances, generation of plastic products, such as pellets, flakes or chips, for example, may require the material to be cooled during its production phase. However, additional re-heating of the cooled plastic material may be required for subsequent processing steps as with crystallizing or drying or crystallizing and drying of the cooled plastic material. Thus, traditional methods and equipment for crystallizing or drying or crystallizing and drying plastic pellets, flakes or chips may not always prove to be the most efficient from an energy standpoint.

Other traditional methods and equipment have been proposed and, in some cases, utilized for crystallizing or drying or crystallizing and drying of plastic products. These may include utilizing a hot liquid pelletizing system in an attempt to keep the plastic material at or near an optimum crystallization temperature. In some examples, the use of an underwater pelletizing system may be incorporated. However, the use of underwater pelletizing systems generally require high-pressure water which can present certain mechanical and safety challenges. In addition to the aforementioned challenges, the use of hot liquid, such as oil, for example, in a pelletizing system can present feasibility challenges such as removing or separating the hot liquid from the plastic material product. Incorporating additional equipment, for example, to remove the hot liquid from the plastic material product can also present cost challenges.

Other traditional equipment, such as shaker decks, have been utilized in processes for drying and/or crystallizing plastic material. Shaker decks are generally horizontal in design and typically cover a large surface area. Many shaker decks are designed to receive an amount of plastic material product, such as plastic pellets, and traverse the plastic material product along a length thereof. In some instances, the plastic material product, such as plastic pellets, received by the shaker deck can be at an elevated temperature. Hence, the plastic pellets, received by the shaker deck, may undergo an amount of crystallizing or drying or crystallizing and drying.

In order to meet certain production demands, the scale of the shaker deck is often increased, for example, to produce a certain output of plastic material such as plastic pellets. One can appreciate that as the scale of the shaker deck increases, the size of the shaker deck may increase both in width and length. This can increase capital cost, for example, in meeting the space requirements otherwise necessary to accommodate one or more shaker decks of increased scale design. In order to accommodate a prescribed production rate of plastic material, the scale of the shaker deck should also be designed not only to receive the material, but also to be large enough to allow sufficient residence time to permit crystallization and/or drying of the received plastic product. This consideration can also affect or mandate the design of the shaker deck and hence, additional cost considerations. In instances, for example, wherein space limitations may not be able to accommodate or facilitate longer shaker decks, a loss in residence time to permit crystallization of the plastic material may be realized by utilizing shorter shaker decks. This can affect the quality of the final plastic material product.

It can also be challenging to control the temperature of plastic products received onto the shaker deck, especially for large scale production. For example, for larger production requirements, plastic products received by the shaker deck may build up to a depth on the shaker deck. For crystallizing or drying or crystallizing and drying, the plastic product material may be received at elevated temperatures upon the shaker deck. Hence, a possibility exists for the plastic product, such as plastic pellets, to stick together as they traverse a length of the shaker deck. This, too, can affect the quality of the final plastic material product. It can also lead to additional waste of materials, for instance, by discarding material stuck together and otherwise unusable per customer demand.

It is accordingly a primary object of the invention to provide a method and system that can reduce an amount of additional equipment and associated expense(s) required to obtain an acceptable level of crystallizing or drying or crystallizing and drying of plastic materials.

### SUMMARY OF THE INVENTION

The foregoing needs are met, to a great extent, by the present invention, wherein in one aspect a method of processing a polymer is provided that in some embodiments includes providing a molten polymer; processing the polymer into malleable components, delivering the components to a conveying surface spirally wound about a central axis, and urging the components along the length of the conveying surface. The method may also include crystallizing or drying or crystallizing and drying the components on the conveying surface.

In accordance with another aspect of the present invention, a method of processing a polymer is provided that in some embodiments includes providing a molten polymer, processing the polymer into malleable components, delivering the components to a conveying surface spirally wound about a central axis, and vibrating the conveying surface to urge the components along the length of the conveying surface. The method may also include crystallizing or drying or crystallizing and drying the components on the conveying surface.

In accordance with another aspect of the present invention, a method of processing a polymer is provided that in some embodiments includes providing a molten polymer, processing the polymer into malleable components, delivering the components at approximately 140° C. to a conveying surface spirally wound about a central axis, and vibrating the conveying surface to urge the components along the length of the conveying surface. The method may also include crystallizing or drying or crystallizing and drying the components on the conveying surface to produce a dryness of less that 0.05% water by mass and a crystallinity of greater than 30%.

In accordance with yet another aspect of the present invention, a system of processing a polymer is provided that in some embodiments includes a molten polymer, a means for processing the polymer into malleable components, a means for delivering the components to a conveying surface spirally wound about a central axis, and a means for urging the components along the length of the conveying surface. The system may also include a means for crystallizing or drying or crystallizing and drying the components on the conveying surface.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is a schematic illustration of a commercial plastic material process according to an exemplary embodiment of the invention.

FIG. 2 is a perspective view of a vibratory spiral elevator according to an exemplary embodiment of the invention.

FIG. 3 is a perspective view of a vibratory spiral elevator according to another exemplary embodiment of the invention.

FIG. 4 illustrates an exemplary feed tray according to an exemplary embodiment of the invention.

FIG. 5 illustrates an exemplary conveying surface sidewall according to an exemplary embodiment of the invention.

### DESCRIPTION OF THE EMBODIMENTS

The invention in some preferred embodiments utilizes a vibratory, spiral elevator for the purpose of drying, crystallizing, providing temperature control of the crystallization process, initial gas stripping (such as for acid aldehyde (AA)), and conveying of plastic (PET, PE, PP) components, such as pellets, flakes or chips. The elevator may be fed by any number (or combinations) of upstream pieces of process equipment including, for examples, a strand cutter, an underwater pelletizer, a static de-watering device (such as a sieve or hydroclone), a centrifugal de-watering device (such as a centrifugal dryer or centrifuge), etc. As the pellets, flakes or chips travel up (or down) the spiral elevator they crystallize or dry (such as via evaporation) or crystallize and dry. The elevator may convey the pellets, flakes or chips to any number or combinations of downstream process equipment including, for examples, a storage silo (such as for railcar loading), a bin (such as for further gas stripping e.g., AA, or other de-gassing process), a pneumatic or hydraulic conveying system, etc. Preferred embodiments of the invention will now be described with reference to the drawing figures, in which like reference numerals refer to like parts throughout.

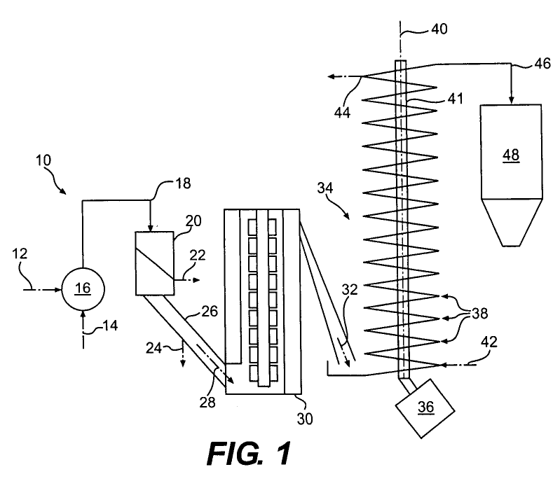

FIG. 1. illustrates a commercial process 10 for processing plastic materials such as PET, PE or PP pellets, flakes or chips. For illustrative purposes, processing of PET into pellets is described according to an exemplary embodiment of the invention. However, it will be readily appreciated that the disclosure should not be limited by producing only PET, but, rather other polymers may be produced such as polyesters, polyamides, polyurethanes, polyolefins or a copolymer thereof.

As shown in FIG. 1, molten PET 12 is fed to underwater pelletizer 16. In a preferred embodiment, the temperature of molten PET 12 is approximately 280° C. Water 14 is provided to the underwater pelletizer 16, for example, at approximately 90° C. to form a water and pellet slurry. The aforementioned temperatures may facilitate keeping the core of produced pellets above the crystallization temperature. The water and pellet slurry 18 may be supplied to additional processing equipment such as agglomerate catcher 20. The agglomerate catcher 20 filters out agglomerates 22 from the water/pellet slurry. The bulk of water 24 may be removed from the water and pellet slurry during a first de-watering stage 26. The pellets and residual water 28 may be supplied to additional processing equipment such as to centrifugal dryer 30. In some embodiments, the pellets and residual water 28 are hydraulically conveyed to centrifugal dryer 30. In a preferred embodiment, the pellets are conveyed to the centrifugal dryer 30 in an in-line residence time of approximately 3 seconds. An in-line residence time of approximately 3 seconds may help ensure that the core of the pellets remain at a temperature above the crystallization temperature. Upon entry into centrifugal dryer 30, the pellets may contain approximately 5% water by mass.

The centrifugal dryer 30 dries the pellets such that, in a preferred embodiment, they retain only a small amount of residual moisture. The pellets having only a small amount of residual moisture 32 may be supplied from an outlet of the centrifugal dryer 30 to additional processing equipment such as to spiral elevator 34. In a preferred embodiment, pellets 32 enter the spiral elevator 34 at a temperature of approximately 140° C. At this temperature, the core of pellets 32 are hot enough to allow a crystallization reaction to occur.

A design of the spiral elevator may include a continuous conveying surface 38 which is preferably wound about a central axis 40 to create a vertical spiral path. The conveying surface 38 can receive material, such as pellets 32, and is further designed to convey the material along its path as discussed below. In some embodiments, the central axis 40 may include a tubular structure 41. Tubular structure 41 may provide support to the overall structure of spiral elevator 34. In some embodiments, tubular structure 41 may also be configured to provide temperature treatment to materials traversing along conveying surface 38 as will be further discussed below.

The spiral design may be advantageous in conserving operation space since an element of the design includes a degree of vertical deployment of material such as pellets 32. This can reduce the operation space required to process pellets 32 for crystallization and drying. This, in turn, may also preserve operational costs, since less space is required to be obtained for crystallizing and drying the aforementioned material than for other traditional equipment. An additional advantage of the spiral path design of conveying surface 38 may include creating a longer processing time, or residence time, for material, such as for pellets 32 undergoing crystallization and drying. This is because the surface design of other traditional equipment may be more limited in overall length, and hence, residence time for material to undergo crystallization and drying. Thus, the completeness of crystallization and drying for other traditional equipment may lag in comparison to the invention as described herein, since the comparable residence times may not readily be obtained by traditional equipment.

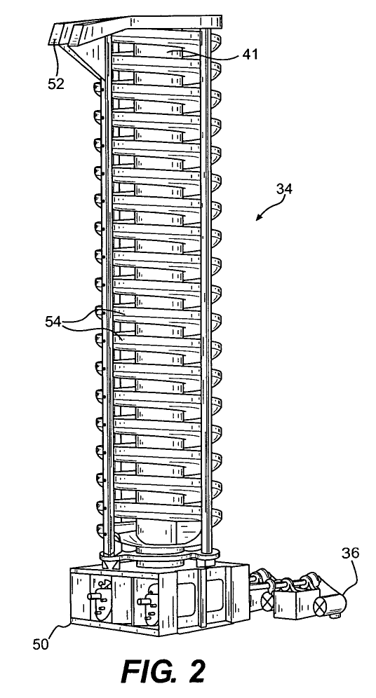

In a preferred embodiment, spiral elevator 34 produces vibratory motion to gently toss material forward along a prescribed pathway, such as conveying surface 38, without degradation to the material. This feature may be advantageous over some traditional equipment which, in some cases, can produce an amount of degradation to the material during processing. Vibratory forces may be transmitted to conveying surface 38 in order to produce vibrations along the surface thereof. In one embodiment, the vibrations may be produced by a drive motor 36 coupled to the spiral elevator 34 as shown, for example in FIGS. 1-2. Thus, in a preferred embodiment, as pellets 32 are supplied to the spiral elevator 34, vibratory forces are applied to conveying surface 38 to translate movement of pellets 32 along a path thereof. In some embodiments, pellets 32 are supplied generally to the bottom of spiral elevator 34 such that vibratory forces urge pellets 32 to travel up the spiral path of conveying surface 38. Turning to FIG. 1, as pellets 32 are received by spiral elevator 34, the motor 36 vibrates the spiral elevator 34 to convey pellets 32 up the spiral path of the conveying surface 38. In an alternative embodiment, pellets 32 may be supplied generally at a top of the spiral elevator 34 such that vibratory forces urge pellets 32 to travel down the spiral path of conveying surface 38.

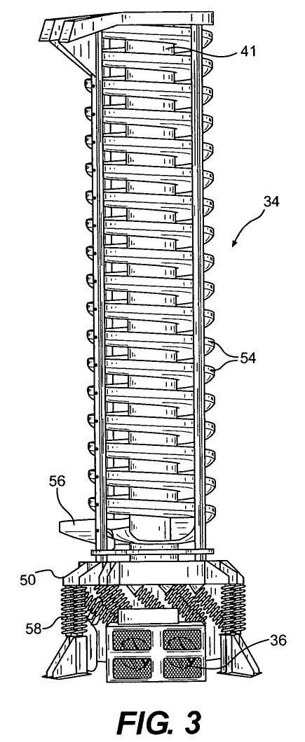

In an alternate embodiment, motor 36 may be coupled to additional equipment for generating vibratory forces such as amplification springs 58 shown, for example, in FIG. 3. An exciter frame 50 in connection with amplification springs 58 may form a coil spring drive to which the spiral elevator 34 is mounted. An exciting force, such as one produced by drive motor 36, may be coupled to exciter frame 50 to produce vibratory forces. The vibratory forces may be amplified through amplification springs 58 of the coil spring system and transmitted to conveying surface 38 of spiral elevator 34.

It is desirable for pellets 32 to crystallize and dry as they travel up (or in some embodiments down) the spiral path of conveying surface 38. Crystallization may occur through a variety of means including, for example, through retained heat of the pellets 32 or generated or supplemental heat applied to the pellets 32. Drying may be obtained through evaporation or, in some embodiments, aided by forced convection. Both crystallization and drying time of pellets 32 may be affected by an amount of time pellets 32 traverse an entire length of conveying surface 38. This amount of time, or residence time, may be directly affected by the frequency of vibration produced by motor 36. Thus, controlling an amount of vibratory force produced via motor 36 can facilitate controlling the residence time of pellets 32 to control crystallization and drying while traversing along conveying surface 38.

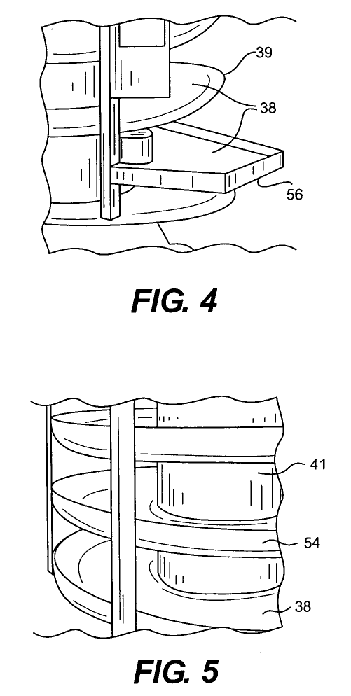

In one embodiment, pellets 32 may be received onto conveying surface 38 of spiral elevator 34 via feed tray 56 as shown, for example, in FIG. 4. Conveying surface 38 may be comprised of a variety of materials including, for example, steel alloy or stainless steel material. Optionally, conveying surface 38 may be coated such as with a plasma or Teflon™ product. Conveying surface 38 may comprise a variety of shapes including, for example, a helical design. Various sidewalls may be attached to or extend from edges 39 of conveying surface 38. Some examples may include sidewalls having radiused comers or shrouds 54 as shown, for example, in FIG. 5. Alternatively conveying surface 38 may comprise a closed configuration such as a tubular or pipe configuration (not shown). Such configuration may lend itself for special applications such as in an inert atmosphere and where conduction heating or cooling is beneficial.

An amount of temperature control may be employed during crystallization and drying of pellets 32 along points or to zoned areas of the conveying surface 38 of spiral elevator 34. Examples of temperature control may include air circulation for convection heating or cooling, enclosed conveying surface pathways such as jacketed spiral paths of conveying surface 38 for contact heating or cooling, quenching such as via water sprays, extended product retention for curing and conveying surface design such as shrouds for atmosphere control. Advantages of temperature control in spiral elevator 34 (versus traditional equipment) may include better contact of materials along conveying surface 38 with a heat transfer medium. Another advantage may include easier temperature zoning along spiral elevator 34 which may enable more precise cooling, heating, or a combination of heating and cooling of material along conveying surface 38.

In a preferred embodiment, pellets 32 enter spiral elevator 34 at 140° C. such that crystallization and drying may occur along spiral elevator 34. However, it may be desired to provide additional heating, cooling, or a combination of heating and cooling to pellets 32 while on spiral elevator 34. This may be to affect an amount of crystallization and drying desired upon pellets 32. Turning again to FIG. 1, a heat transfer medium may be supplied to spiral elevator 34 such as at inlet 42. The heat transfer medium may exit from spiral elevator 34 such as via outlet 44. Examples of heat transfer media include, air, water, oil, or other gases and fluids which may alter temperature of the processed material such as pellets 32. While inlet 42 and outlet 44 are shown at specific locations of spiral elevator 34, it will be appreciated that the locations shown in FIG. 1 are for illustrative purposes only and that other locations may be utilized.

Deployment or withdrawal of the heat transfer medium may occur at various points of the spiral elevator 34. In some embodiments, the heat transfer medium may be deployed and withdrawn at specific locations. This may include supplying an inlet and outlet along various locations, for examples, internal or external to tubular structure 41. Means for supplying the heat transfer medium may include piping, conduits, or other materials sufficient for supplying a heat transfer medium to various locations of tubular structure 41. In some embodiments, inlet 42 may comprise multiple inlets and outlet 44 may comprise multiple outlets to allow cooling and/or heating of various zones of spiral elevator 34. Again, the inlets and outlets may include locations internal or external to tubular structure 41 or a combination of both. In some embodiments, spiral elevator 34 may be partially or completely enclosed to thermally regulate a processing environment as material, such as pellets 32, is subjected to one or more heat transfer media. Providing additional temperature control via introduction of the aforementioned heat transfer medium can affect an amount of crystallization and drying desired upon pellets 32.

As pellets 32 travel along the spiral path of conveying surface 38, they will crystallize (for example, via retained heat, generated or supplemental heat) and dry (for example, through evaporation or forced convention). Additionally, an initial gas stripping process may also begin such that AA stripping commences as pellets 32 de-gas to its surrounding atmosphere. Again, a degree of AA stripping may be influenced by an amount of supplemental heat transfer medium introduced to pellets 32 in spiral elevator 34.

Upon traversing an entire length of the conveying surface 38, pellets 32 will have undergone crystallization and drying. In a preferred embodiment, pellets 32 achieve a dryness of less than 0.05% water by mass and a crystallinity of greater than 30% upon leaving the spiral elevator 34. Pellets 32 may be delivered 46 to additional downstream process equipment 48 via outlet 52 of spiral elevator 34. Additional downstream process equipment 48 may include a storage silo, a bin (e.g., for further gas (AA) stripping (or other de-gassing process)), a pneumatic or hydraulic conveying system, etc. In some embodiments, an advantage of spiral elevator 34 includes an ability to deliver products (such as pellets 32), as a conveying mechanism, to another process equipment 48. This advantage is due to the spiral elevator 34 being able to deliver products at elevated heights and accommodate larger process equipment 48, for example, those receiving the delivered products. This can also eliminate employing other equipment such as pneumatic conveying systems (and their associated costs, space requirements, and possible pellet degradation) which may be required to deliver products from other traditional equipment for crystallizing and/or drying pellets.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of processing a polymer comprising:
providing a molten polymer;
processing said polymer into malleable components;
delivering the components to a conveying surface spirally wound about a central axis;
urging the components along the length of the conveying surface; and
crystallizing or drying or crystallizing and drying the components on the conveying surface.

2. The method of claim 1, further comprising:
using vibratory forces to urge the components along the length of the conveying surface.

3. The method of claim 2, further comprising:
producing the vibratory forces via a drive motor.

4. The method of claim 3, wherein the drive motor is coupled to the conveying surface.

5. The method of claim 1, further comprising:
applying supplemental temperature control to the components along a length of the conveying surface to affect crystallizing or drying or crystallizing and drying of the components.

6. The method of claim 5, wherein the supplemental temperature control includes heating or cooling or both.

7. The method of claim 5, further comprising:
utilizing one or more heat transfer media to provide supplemental temperature control to the components.

8. The method of claim 7, wherein the heat transfer medium is selected from the group consisting of air, water and oil.

9. The method of claim 1, further comprising:
delivering the crystallized and dried components directly from the conveying surface to receiving equipment.

10. The method of claim 9, wherein the receiving equipment is selected from the group consisting of a silo, a bin and a conveying system.

11. The method of claim 1, wherein the components are delivered to the conveying surface at a temperature of approximately 140° C.

12. The method of claim 1, wherein the processing step further comprises:
subjecting the polymer to an underwater pelletizer to form pelletized components;
mixing water with the pelletized components to form a water and pellet slurry;
filtering agglomerates from the water and pellet slurry; and
removing excess moisture from the water and pellet slurry.

13. The method of claim 12, wherein the polymer is subjected to the underwater pelletizer at a temperature of approximately 280° C. and the water mixed with the pelletized components has a temperature of approximately 90° C.

14. The method of claim 12, wherein the step for removing excess moisture includes de-watering the water and pellet slurry and subjecting the de-watered pellets to a dryer.

15. The method of claim 13, wherein the de-watered pellets contain approximately 5% water by mass prior to being subjected to the dryer.

16. The method of claim 1, wherein the components have a dryness of less that 0.05% water by mass and a crystallinity of greater than 30% after said components have been crystallized and dried.

17. A method of processing a polymer comprising:
providing a molten polymer;
processing said polymer into malleable components;
delivering the components to a conveying surface spirally wound about a central axis;
vibrating the conveying surface to urge the components along the length of the conveying surface; and
crystallizing or drying or crystallizing and drying the components on the conveying surface.

18. The method of claim 17, further comprising:
producing the vibratory forces via a drive motor.

19. The method of claim 18, wherein the drive motor is coupled to the conveying surface.

20. The method of claim 17, further comprising:
applying supplemental temperature control to the components along a length of the conveying surface to affect crystallizing or drying or crystallizing and drying of the components.

21. A method of processing a polymer comprising:
providing a molten polymer;
processing said polymer into malleable components;
delivering the components at approximately 140° C. to a conveying surface spirally wound about a central axis;
vibrating the conveying surface to urge the components along the length of the conveying surface; and
crystallizing or drying or crystallizing and drying the components on the conveying surface to produce a dryness of less that 0.05% water by mass and a crystallinity of greater than 30%.

22. The method of claim 21, further comprising:
applying supplemental temperature control to the components along a length of the conveying surface to affect crystallizing or drying or crystallizing and drying of the components.

23. A system for processing a molten polymer comprising:
means for processing said polymer into malleable components;
means for delivering the components to a conveying surface spirally wound about a central axis;
means for urging the components along the length of the conveying surface; and
means for crystallizing or drying or crystallizing and drying the components on the conveying surface.

24. The system of claim 23, wherein the means for processing includes using equipment selected from the group consisting of an underwater pelletizer, a strand cutter, a static de-watering device and a centrifugal de-watering device.

25. The system of claim 23, wherein the delivering means comprises a conveyor system.

26. The system of claim 23, wherein the urging means comprises vibratory forces applied to the conveying surface.

27. They system of claim 27, wherein the vibratory forces are produced by a drive motor.

28. The system of claim 23, wherein the means for crystallizing or drying or crystallizing and drying comprises means for applying supplemental temperature control to the components along a length of the conveying surface to affect crystallizing or drying or crystallizing and drying of the components.

29. The system of claim 29, wherein the supplemental temperature control includes heating or cooling or both.

30. The system of claim 29, further comprising:
means for utilizing one or more heat transfer mediums to provide supplemental temperature control to the components.
